(19) United States
(12) Patent Application Publication
(10) Pub. No.: US 2023/0369882 A1
(43) Pub. Date: Nov. 16, 2023

(54) PARALLEL BATTERY CHARGER

(71) Applicant: Cirrus Logic International Semiconductor Ltd., Edinburgh (GB)

(72) Inventors: John L. MELANSON, Austin, TX (US); Eric J. KING, Austin, TX (US)

(73) Assignee: Cirrus Logic International Semiconductor Ltd., Edinburgh (GB)

(21) Appl. No.: 18/308,480

(22) Filed: Apr. 27, 2023

Related U.S. Application Data
(60) Provisional application No. 63/342,178, filed on May 16, 2022.

(51) Int. Cl. H02J 7/34; H02M 1/00; H02J 7/04

(52) U.S. Cl. CPC H02J 7/345; H02M 1/0087; H02J 7/04; H02J 2207/20

(57) ABSTRACT

A battery charging system may include a first current source for charging a battery that provides a direct current for charging the battery and a second current source for charging the battery that provides an alternating current for charging the battery and that provides electrical energy for operation of a system load of the battery during discharging of the battery. Further, a battery charging system may include a first current source for charging a battery that provides a direct current for charging the battery and a second current source for charging the battery that provides an alternating current at a frequency of at least 5 KHz for charging the battery.

### RELATED APPLICATION

The present disclosure claims priority to United States Provisional Patent Application Ser. No. 63/342,178, filed May 16, 2022, which is incorporated by reference herein in its entirety.

### FIELD OF DISCLOSURE

The present disclosure relates in general to circuits for electronic devices, including without limitation personal audio devices such as wireless telephones and media players, and more specifically, to a battery charging system including parallel direct current (DC) and alternating current (AC) charging paths.

### BACKGROUND

Portable electronic devices, including wireless telephones, such as mobile/cellular telephones, tablets, cordless telephones, mp3 players, smart watches, health monitors, and other consumer devices, are in widespread use. Such a portable electronic device may include a battery (e.g., a lithium-ion battery) for powering components of the portable electronic device. Typically, such batteries used in portable electronic devices are rechargeable, such that when charging, the battery converts electrical energy into chemical energy which may later be converted back into electrical energy for powering components of the portable electronic device.

Battery charging systems are desired which enable fast charging of a battery while also maximizing power efficiency during charging.

### SUMMARY

In accordance with the teachings of the present disclosure, one or more disadvantages and problems associated with existing approaches to battery charging may be reduced or eliminated.

In accordance with embodiments of the present disclosure, a battery charging system may include a first current source for charging a battery that provides a direct current for charging the battery and a second current source for charging the battery that provides an alternating current for charging the battery and that provides electrical energy for operation of a system load of the battery during discharging of the battery.

In accordance with these and other embodiments of the present disclosure, a battery charging system may include a first current source for charging a battery that provides a direct current for charging the battery and a second current source for charging the battery that provides an alternating current at a frequency of at least 5 KHz for charging the battery.

In accordance with these and other embodiments of the present disclosure, a method may include charging a battery with a first current source that provides a direct current for charging the battery and charging the battery with a second current source that provides an alternating current for charging the battery and that provides electrical energy for operation of a system load of the battery during discharging of the battery.

In accordance with these and other embodiments of the present disclosure, a method may include charging a battery with a first current source that provides a direct current for charging the battery and charging the battery with a second current source that provides an alternating current at a frequency of at least 5 KHz for charging the battery.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an example block diagram of selected components of a system for charging a battery of an electronic device, in accordance with embodiments of the present disclosure; and

FIG. 2 illustrates example waveforms of currents output from each of a DC charging path and an AC charging path in the system depicted in FIG. 1, in accordance with embodiments of the present disclosure.

### DETAILED DESCRIPTION

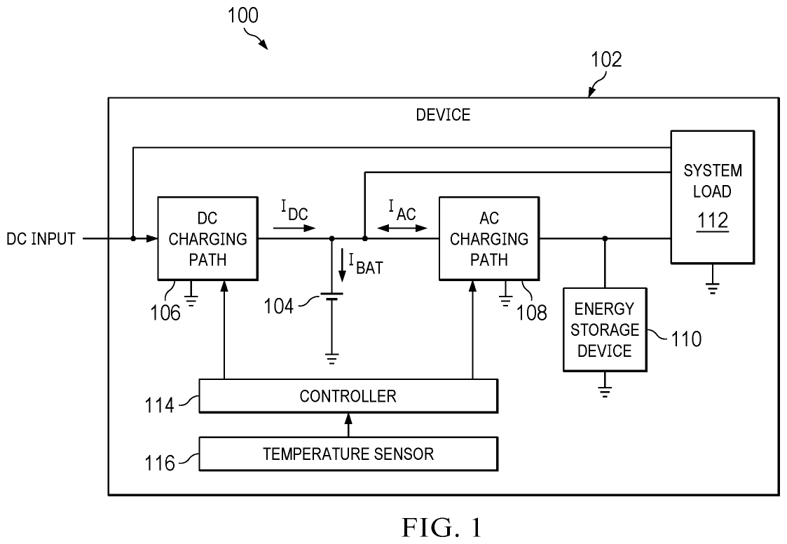

FIG. 1 illustrates an example block diagram of selected components of a system 100 for charging a battery 104 of an electronic device 102, in accordance with embodiments of the present disclosure. Electronic device 102 may comprise any suitable electronic device, including without limitation a mobile phone, smart phone, tablet, laptop/notebook computer, media player, handheld, smart watch, gaming controller, power tool, electric toothbrush, flashlight, etc.

As shown in FIG. 1, electronic device 102 may include a DC charging path 106 coupled between a DC input of electronic device 102 and battery 104 and an AC charging path 108 coupled between battery 104 and an energy storage device 110. Electronic device 102 may also include a system load 112 coupled to one or more of the DC input, battery 104, and energy storage device 110, such that system load 112 may be powered from one or more of the DC input, battery 104, and energy storage device 110.

Battery 104 may include any system, device, or apparatus configured to convert chemical energy stored within battery 104 to electrical energy. For example, in some embodiments, battery 104 may be integral to device 102, and battery 104 may be configured to deliver electrical energy to system load 112, energy storage device 110, and other components of device 102. Further, battery 104 may also be configured to recharge, in which it may convert electrical energy received by battery 104 from either or both of DC charging path 106 and AC charging path 108 into chemical energy to be stored for later conversion back into electrical energy. As an example, in some embodiments, battery 104 may comprise a lithium-ion battery. Battery 104 may comprise a single cell, multiple cells in series, multiple cells in parallel, or a combination of multiple series and parallel cells.

DC charging path 106 may include a wired power port configured to receive electrical energy from an external source (e.g., a wall charger) via a power cable. DC charging path 106 may additionally or alternatively include a wireless power port configured to receive electrical energy from an external wireless charger. DC charging path 106 may comprise any suitable system, device, or apparatus configured to receive energy from the DC input and transfer such energy to battery 104 to charge battery 104. DC charging path 106 may be implemented by any suitable direct current source, including without limitation a buck converter, other power converter, and a linear current source.

AC charging path 108 may comprise any suitable system, device, or apparatus configured to transfer electrical energy back and forth between battery 104 and energy storage device 110 with an AC current. For example, in some embodiments, AC charging path 108 may comprise a switching converter which is operated as a boost converter when transferring energy from battery 104 to energy storage device 110 and as a buck converter when transferring energy from energy storage device 110 to battery 104. In these and other embodiments, AC charging path 108 may comprise an inductor-based switch-mode power converter.

Energy storage device 110 may comprise any suitable system, device, or apparatus configured to store electrical energy. For example, in some embodiments, energy storage device 110 may comprise a capacitor. In yet other embodiments, energy storage device 110 may comprise a battery.

System load 112 may comprise a plurality of electrical and electronic components configured to carry out the functionality of device 102, including without limitation microphones, speakers, radio antennas, haptic actuators, display devices, lights, motors, etc. System load 112 may be configured to be powered by DC charging path 106 and/or AC charging path 108 when charging of battery 104 is disabled, and may be optionally powered by DC charging path 106 and/or AC charging path 108 when charging of battery 104 is enabled. In some embodiments, system load 112 may be powered directly from battery 104, from DC charging path 106, from AC charging path 108, from the DC input, and/or from energy storage device 110.

System 100 may further include a controller 114 configured to control operation of DC charging path 106, AC charging path 108, and/or other components of system 100. For example, controller 114 may control operation of DC charging path 106 and AC charging path 108 by controlling commutation of switches internal to DC charging path 106 and AC charging path 108.

System 100 may also include a temperature sensor 116. Temperature sensor 116 may include any system, device, or apparatus (e.g., a thermistor or other temperature-dependent circuit element) configured to generate a signal which is a function of an actual temperature of battery 104 or proximate to battery 104.

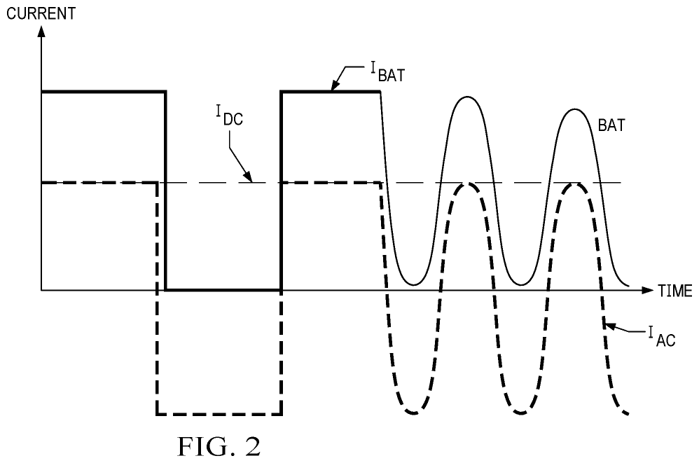

In operation, during active charging of battery 104, controller 114 may cause two current sources to charge battery 104: one predominantly DC current source implemented by DC charging path 106 and one predominantly AC current source implemented by AC charging path 108. FIG. 2 illustrates example waveforms of DC current I_{DC} output from DC charging path 106 and AC current I_{AC} output from AC charging path 108, in accordance with embodiments of the present disclosure. AC current I_{AC} may be an approximation of a sine wave, an approximation of a rectangular wave, an approximation of a triangular wave, or other harmonic wave. In some embodiments, the shape of the wave of AC current I_{AC} may vary, for example, from rectangular to sine, during a charging period (e.g., a period of 100 seconds), such that at a first time during the charging period AC current I_{AC} may have a first wave (e.g., sinusoidal, rectangular, triangular) shape and at a second time during the charging period AC current I_{AC} may have a second wave shape. In these and other embodiments, AC current I_{AC} may have a frequency of between 1 KHz and 100 KHz. In these and other embodiments, a combination of waveforms may be used. Further, AC charging path 108 may mix and match any signal that has a zero DC average.

In some embodiments, controller 114 may be configured to control AC charging path 108 such that AC current I_{AC} may have a frequency of greater than 5 KHz. Such operation may be advantageous because chemical time constants of battery 104 may be 1 millisecond or higher. Operation at frequencies above 5 kHz may avoid the chemical reactions that may take place in the anode material (e.g., graphite) of a lithium ion battery. In the anode material of a lithium ion battery during charging, a lithium ion may be intercalated (or bonded) with an electron in the lattice structure of graphite particles. The ease of this process is influenced by multiple effects such as temperature, the amount of lithium particles already present in the graphite particles as well as the location of the graphite particle relative to the separator and collector of the anode terminal. This intercalation process has a time constant that can be measured and modeled as being much slower than 5 kHz. As such, the application of an AC waveform above 5 kHz may avoid interactions with the intercalation process.

In these and other embodiments, controller 114 may be configured to modulate a frequency of AC current I_{AC} in order to regulate a temperature (e.g., measured by temperature sensor 116) of or proximate to battery 104.

AC charging path 108 may have an efficiency of less than 100%, due to undesired loss of energy converted to heat during transfer of energy from battery 104 to energy storage device 110 or from energy storage device 110 to battery 104. As a consequence, some DC current will necessarily be generated by AC charging path 108, associated with the loss. It is desirable to minimize this loss, and to keep most of the current generated by AC charging path 108 to be alternating. DC current I_{DC} may be increased to account for the undesired loss in AC charging path 108. DC current I_{DC} may be used to minimize this undesired current. DC current I_{DC} may be increased when losses of AC charging path 108 increase, and may be decreased when losses of AC charging path 108 decrease.

Having both a DC charging current delivered to battery 104 and an AC charging excitation may have advantages. DC current I_{DC} may replenish charge of battery 104 while AC current I_{AC} may improve quality of the charging. Thus, waveform(s) generated by DC charging path 106 and AC charging path 108 may allow for more flexibility in the charging waveform, faster charge times, and improved battery life. Further, selection of waveform(s) used may allow for optimization of charging.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. A battery charging system, comprising:
a first current source for charging a battery that provides a direct current for charging the battery; and
a second current source for charging the battery that provides an alternating current for charging the battery and that provides electrical energy for operation of a system load of the battery during discharging of the battery.

2. The battery charging system of claim 1, wherein the second current source comprises a switch-mode converter.

3. The battery charging system of claim 2, further comprising an energy storage device, and wherein:
the switch-mode converter is coupled between the battery and the energy storage device, and is configured to transfer electrical energy from the battery to the energy storage device and vice versa.

4. The battery charging system of claim 3, wherein the energy storage device is a capacitor.

5. The battery charging system of claim 1, wherein the first current source comprises a switch-mode converter.

6. The battery charging system of claim 1, wherein the battery comprises a lithium-ion cell.

7. The battery charging system of claim 1, wherein within a charging period of the battery, a waveform of the alternating current has a first waveform shape at a first time within the charging period and a second waveform shape at a second time within the charging period.

8. The battery charging system of claim 7, wherein one of the first waveform shape and the second waveform shape is one of the following: a rectangular wave, a triangular wave, and a sinusoidal wave.

9. The battery charging system of claim 7, wherein at least one of the first waveform shape and the second waveform shape has zero direct current.

10. The battery charging system of claim 1, wherein the alternating current has a frequency of between 1 KHz and 100 KHz.

11. The battery charging system of claim 1, wherein the alternating current has a frequency of at least 5 KHz.

12. The battery charging system of claim 1, wherein the direct current is dependent upon an amount of power loss of the second current source.

13. The battery charging system of claim 1, wherein a frequency of the alternating current is modulated in order to regulate a temperature associated with the battery.

14. A battery charging system, comprising:
a first current source for charging a battery that provides a direct current for charging the battery; and
a second current source for charging the battery that provides an alternating current at a frequency of at least 5 KHz for charging the battery.

15. The battery charging system of claim 14, wherein the second current source comprises a switch-mode converter.

16. The battery charging system of claim 15, further comprising an energy storage device, and wherein:
the switch-mode converter is coupled between the battery and the energy storage device, and is configured to transfer electrical energy from the battery to the energy storage device and vice versa.

17. The battery charging system of claim 16, wherein the energy storage device is a capacitor.

18. The battery charging system of claim 14, wherein the first current source comprises a switch-mode converter.

19. The battery charging system of claim 14, wherein the battery comprises a lithium-ion cell.

20. The battery charging system of claim 16, wherein within a charging period of the battery, a waveform of the alternating current has a first waveform shape at a first time within the charging period and a second waveform shape at a second time within the charging period.

21. The battery charging system of claim 20, wherein one of the first waveform shape and the second waveform shape is a rectangular wave.

22. The battery charging system of claim 20, wherein one of the first waveform shape and the second waveform shape is one of the following: a rectangular wave, a triangular wave, and a sinusoidal wave.

23. The battery charging system of claim 14, wherein the alternating current has a frequency of between 1 KHz and 100 KHz.

24. The battery charging system of claim 14, wherein the alternating current has a frequency of at least 5 KHz.

25. The battery charging system of claim 14, wherein the direct current is dependent upon a an amount of power loss of the second current source.

26. The battery charging system of claim 14, wherein a frequency of the alternating current is modulated in order to regulate a temperature associated with the battery.

27. The battery charging system of claim 14, wherein at least one of the first current source and the second current source is configured to provide electrical energy to a system load of a device housing the battery.

28. A method comprising:
charging a battery with a first current source that provides a direct current for charging the battery; and
charging the battery with a second current source that provides an alternating current for charging the battery and that provides electrical energy for operation of a system load of the battery during discharging of the battery.

29. The method of claim 28, further comprising transferring electrical energy from the battery to an energy storage device and vice versa, wherein the second current source is coupled between the battery and the energy storage device

30. The method of claim 28, wherein within a charging period of the battery, a waveform of the alternating current has a first waveform shape at a first time within the charging period and a second waveform shape at a second time within the charging period.

31. The method of claim 30, wherein one of the first waveform shape and the second waveform shape is one of the following: a rectangular wave, a triangular wave, and a sinusoidal wave.

32. The method of claim 30, wherein at least one of the first waveform shape and the second waveform shape has zero direct current.

33. The method of claim 28, wherein the alternating current has a frequency of between 1 KHz and 100 KHz.

34. The method of claim 28, wherein the alternating current has a frequency of at least 5 KHz.

35. The method of claim 28, wherein the direct current is dependent upon an amount of power loss of the second current source.

36. The method of claim 28, wherein a frequency of the alternating current is modulated in order to regulate a temperature associated with the battery.

37. A method comprising:
charging a battery with a first current source that provides a direct current for charging the battery; and
charging the battery with a second current source that provides an alternating current at a frequency of at least 5 KHz for charging the battery.

38. The method of claim 37, further comprising transferring electrical energy from the battery to an energy storage device and vice versa, wherein the second current source is coupled between the battery and the energy storage device.

39. The method of claim 37, wherein within a charging period of the battery, a waveform of the alternating current has a first waveform shape at a first time within the charging period and a second waveform shape at a second time within the charging period.

40. The method of claim 39, wherein one of the first waveform shape and the second waveform shape is one of the following: a rectangular wave, a triangular wave, and a sinusoidal wave.

41. The method of claim 39, wherein at least one of the first waveform shape and the second waveform shape has zero direct current.

42. The method of claim 37, wherein the alternating current has a frequency of between 1 KHz and 100 KHz.

43. The method of claim 37, wherein the alternating current has a frequency of at least 5 KHz.

44. The method of claim 37, wherein the direct current is dependent upon a an amount of power loss of the second current source.

45. The method of claim 37, wherein a frequency of the alternating current is modulated in order to regulate a temperature associated with the battery.

46. The method of claim 37, wherein at least one of the first current source and the second current source is configured to provide electrical energy to a system load of a device housing the battery.
